(19) United States
(12) Patent Application Publication
(10) Pub. No.: US 2024/0369676 A1
(43) Pub. Date: Nov. 7, 2024

(54) METHOD OF AND ELECTRONIC DEVICE FOR TRACKING VEHICLE BY USING EXTENDED KALMAN FILTER BASED ON CORRECTION FACTOR

(71) Applicant: Samsung Electronics Co., Ltd., Suwon-si (KR)

(72) Inventors: Seonghwan HYUN, Seoul (KR); Seongcheol KIM, Seoul (KR)

(73) Assignees: Samsung Electronics Co., Ltd., Suwon-si (KR); Seoul National University, R&DB Foundation, Seoul (KR)

(21) Appl. No.: 18/644,732

(22) Filed: Apr. 24, 2024

(30) Foreign Application Priority Data
Apr. 25, 2023 (KR) 10-2023-0054264
Aug. 16, 2023 (KR) 10-2023-0107098

(51) Int. Cl. G01S 7/03; G01S 13/72; H04L 27/26

(52) U.S. Cl. CPC G01S 7/03; G01S 13/72; H04L 27/2637

(57) ABSTRACT

An electronic device includes an antenna configured to receive an orthogonal frequency division multiplex (OFDM) signal reflected from a target vehicle, and processing circuitry configured to estimate a first state vector and a first covariance matrix based on initial state information, the initial state information being received from a target vehicle via a wireless connection, calculate a Kalman gain matrix based on the first state vector and the first covariance matrix, calculate a correction factor based on a statistical characteristic of a discrete observation vector, and update the first state vector and the first covariance matrix based on the correction factor to obtain a second state vector and a second covariance matrix.

### CROSS-REFERENCE TO RELATED APPLICATIONS

This application is based on and claims priority under 35 U.S.C. § 119 to Korean Patent Application Nos. 10-2023-0054264, filed on Apr. 25, 2023 and 10-2023-0107098, filed on Aug. 16, 2023, in the Korean Intellectual Property Office, the disclosures of each of which are incorporated by reference herein in their entireties.

### BACKGROUND

The inventive concepts relate to a vehicle tracking method, and more particularly, to a method of and an electronic device for tracking a vehicle by using an extended Kalman filter (EKF) based on a correction factor.

An orthogonal frequency division multiplex (OFDM)-based radar system is a representative digital transmission technique. When a road side unit (RSU) obtains distance and relative velocity information about a vehicle by using an OFDM-based radar in a vehicle-to-infrastructure (V2I) scenario, observed values corresponding to the information may include a discretization error. The discretization error is determined by the physical layer parameters of an OFDM communication system. A distance resolution is determined by the number of activated subcarriers and a velocity resolution is determined by the number of symbols.

For example, in the case of a 20-MHz bandwidth at a central frequency of 3.5 GHZ, a subcarrier spacing of 15 kHz, and a 10-ms data frame in a new radio (NR) system, a distance resolution of 8.3 m and a velocity resolution of 4.2 m/s are given. Considering a lane width of 3.5 m, the resolution is not suitable for estimating vehicle state information (position and velocity), and thus, the accuracy of real-time vehicle tracking may be insufficient.

### SUMMARY

The inventive concepts provide a method of, and an electronic device for, tracking a vehicle by using an extended Kalman filter (EKF) based on a correction factor to reflect the statistical characteristic of all possible observed values. Embodiments provide a vehicle tracking method considering a discretization error.

According to an aspect of the inventive concepts, there is provided an electronic device including an antenna configured to receive an orthogonal frequency division multiplex (OFDM) signal reflected from a target vehicle, and processing circuitry configured to estimate a first state vector and a first covariance matrix based on initial state information, the initial state information being received from a target vehicle via a wireless connection, calculate a Kalman gain matrix based on the first state vector and the first covariance matrix, calculate a correction factor based on a statistical characteristic of a discrete observation vector, and update the first state vector and the first covariance matrix based on the correction factor to obtain a second state vector and a second covariance matrix.

According to an aspect of the inventive concepts, there is provided an operating method of an electronic device. The operating method includes estimating a first state vector and a first covariance matrix based on initial state information, the initial state information being received from a target vehicle via a wireless connection, calculating a Kalman gain matrix based on the first state vector and the first covariance matrix, calculating a correction factor based on a statistical characteristic of a discrete observation vector, and updating the first state vector and the first covariance based on the correction factor to obtain a second state vector and a second covariance matrix.

According to an aspect of the inventive concepts, there is provided a non-transitory computer-readable medium storing instructions that, when executed by at least one processor, cause the at least one processor to perform an operating method. The operating method includes estimating a first state vector and a first covariance matrix based on initial state information, the initial state information being received from a target vehicle via a wireless connection, calculating a Kalman gain matrix based on the first state vector and the first covariance matrix, calculating a correction factor based on a statistical characteristic of a discrete observation vector, and updating the first state vector and the first covariance based on the correction factor to obtain a second state vector and a second covariance matrix.

### BRIEF DESCRIPTION OF THE DRAWINGS

Embodiments will be more clearly understood from the following detailed description taken in conjunction with the accompanying drawings in which:

FIG. 1 is a diagram of a vehicle tracking system according to embodiments;

FIG. 2 is a diagram of an example of a vehicle tracking system according to embodiments;

FIG. 3 is a block diagram of a road side unit (RSU) according to embodiments;

FIG. 4 shows an example of a quantized observation vector according to embodiments;

FIG. 5 shows an example in which a quantized observation vector moves according to a movement of a target vehicle, according to embodiments;

FIG. 6 shows an example of a conditional observation probability density function according to embodiments;

FIG. 7 is a flowchart of an operating method of an RSU, according to embodiments;

FIG. 8 shows examples of graphs showing improvement in tracking performance, according to embodiments;

FIG. 9 shows examples of graphs showing improvement in tracking performance, according to embodiments; and

FIG. 10 shows examples of graphs showing improvement in tracking performance, according to embodiments.

### DETAILED DESCRIPTION

Hereinafter, embodiments are described in detail with reference to the accompanying drawing.

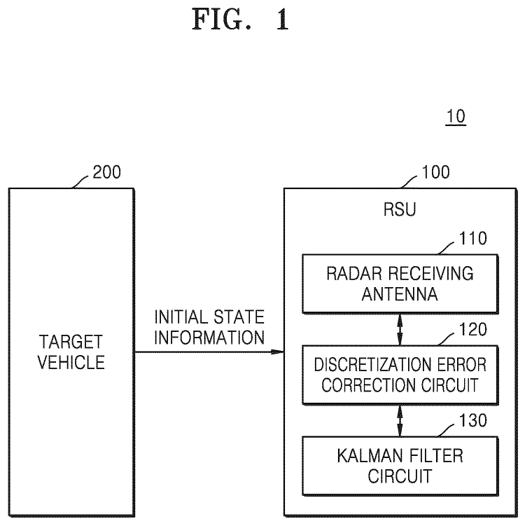

FIG. 1 is a diagram of a vehicle tracking system 10 according to embodiments.

Referring to FIG. 1, the vehicle tracking system 10 may include a road side unit (RSU) 100 and/or a target vehicle 200.

The RSU 100 may track a position (e.g., a real-time position) of the target vehicle 200. The RSU 100 may include a radar receiving antenna 110, a discretization error correction circuit 120, and/or a Kalman filter circuit 130.

The RSU 100 may broadcast an orthogonal frequency division multiplex (OFDM)-based radar signal (hereinafter, referred to as an OFDM signal). The radar receiving antenna 110 may receive an OFDM signal, which has been reflected from the target vehicle 200 after having been broadcast by the RSU 100 to the target vehicle 200. The RSU 100 may track a real-time position of the target vehicle 200, based on the reflected OFDM signal. According to embodiments, the RSU 100 may broadcast the OFDM-based radar signal using the radar receiving antenna 110 and/or another antenna.

The discretization error correction circuit 120 may calculate a correction factor for correcting a discretization error which occurs because the OFDM signal is a discrete signal rather than a continuous signal. The discretization error correction circuit 120 may calculate correction factors for a state vector and a covariance matrix, based on the statistical characteristic(s) of observed values, and may provide the correction factors to the Kalman filter circuit 130. The correction factors are described in detail below.

The Kalman filter circuit 130 may estimate the accurate position and/or velocity of a vehicle by predicting state information based on the correction factors provided from the discretization error correction circuit 120 and updating the state information according to observed values. The Kalman filter circuit 130 may be based on an extended Kalman filter (EKF) for a non-linear system.

The target vehicle 200 may provide the RSU 100 with information necessary (or sufficient) for the RSU 100 to perform real-time position tracking. For example, the target vehicle 200 may establish a wireless connection (e.g., session) with RSU 100. The wireless connection (e.g., session) may correspond to a feedback link. The target vehicle 200 may provide the RSU 100 with initial state information thereof through the feedback link. The state information for representing the state of the target vehicle 200 may include the position and/or the relative velocity of the target vehicle 200.

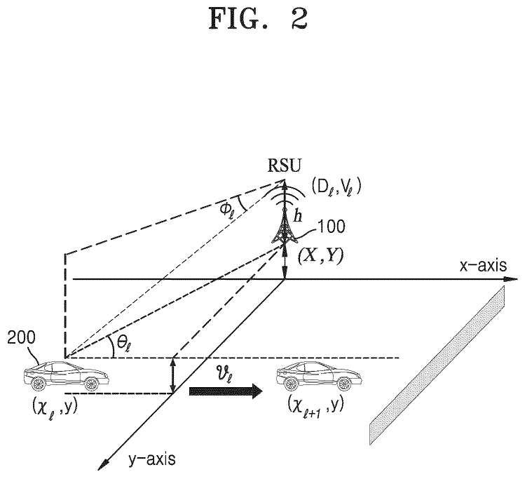

FIG. 2 is a diagram of an example of the vehicle tracking system 10 according to embodiments.

Referring to FIG. 2, a distance [symbol] between the RSU 100 and the target vehicle 200 at an [symbol] -th discrete time may be defined as follows:

$${D}_{ℓ} = \sqrt{{( {x}_{ℓ} - X )}^{2} + {( y - Y )}^{2} + {h}^{2}} , \qquad [ Equation 1 ]$$

wherein ( [symbol] , y) may be the position of the target vehicle 200, (X,Y) may be the position of the RSU 100, and h may be a height. The spatial direction angle of the target vehicle 200 [symbol] may be expressed as a horizontal angle of arrival [symbol] and a vertical angle of arrival [symbol] and is as follows:

$${ψ}_{ℓ} = cos {θ}_{ℓ} cos {ϕ}_{ℓ} = \frac{{x}_{ℓ} - X}{\sqrt{{( {x}_{ℓ} - X )}^{2} + {( y - Y )}^{2} + {h}^{2}}} = \frac{{x}_{ℓ} - X}{{D}_{ℓ}} . \qquad [ Equation 2 ]$$

When the target vehicle 200 is traveling at velocity [symbol] , the relationship between the actual velocity of the target vehicle 200 and the relative velocity of the target vehicle 200 due to the Doppler shift may be as follows.

$${V}_{ℓ} = {v}_{ℓ} {ψ}_{ℓ} = \frac{{f}_{ℓ}^{d} {c}_{0}}{2 {f}_{c}} . \qquad [ Equation 3 ]$$

The Doppler shift is defined as

$${f}_{ℓ}^{d} = \frac{2 {v}_{ℓ}}{{c}_{0}} {f}_{c} {ψ}_{ℓ} ,$$

where f_{c} is a central frequency and c₀ is the speed of light.

According to embodiments, a vehicle state vector may be expressed as a discrete-time linear state-space model. A state-space model at the [symbol] -th discrete time with a sampling interval of Tₛ is defined as follows:

$${t}_{ℓ} = {At}_{ℓ - 1} + {c}_{ℓ - 1} . \qquad [ Equation 4 ]$$

At this time, [symbol] =[ [symbol] , [symbol] ]^{T}∈ [symbol] ²,

$$A = [ \begin{matrix}1 & {T}_{s} \\ 0 & 1\end{matrix} ]$$

is a state transition matrix, and [symbol] is an error variance vector and follows a Gaussian distribution having mean 0 and variance Q_{ω}. At this time, Q_{ω}=σ_{ω}²diag[Tₛ², 1]∈ [symbol] ^{2×2}. Here, [symbol] represents a real number. According to embodiments, the target vehicle 200 may transmit the initial state vector [symbol] to the RSU 100 through the feedback link.

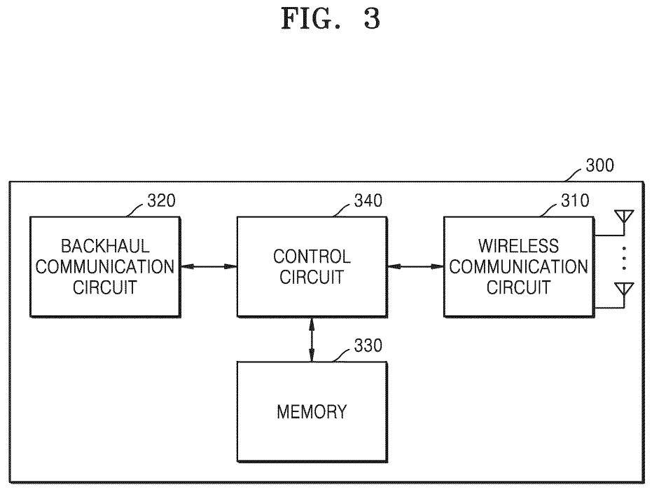

FIG. 3 is a block diagram of an RSU 300 according to embodiments.

Referring to FIG. 3, the RSU 300 may include a wireless communication circuit 310, a backhaul communication circuit 320, a memory 330, and/or a control circuit 340.

According to embodiments, the wireless communication circuit 310 may perform functions for transmitting and receiving signals through a wireless channel. According to embodiments, the wireless communication circuit 310 may perform conversion between a baseband signal and a bit string according to the physical layer standard of a system. For example, the wireless communication circuit 310 may generate complex symbols by encoding and modulating a transmitted bit string during data transmission and may reconstruct a received bit string by demodulating and decoding a baseband signal during data reception. The wireless communication circuit 310 may up-convert a baseband signal into a radio frequency (RF) band signal and transmit the RF band signal through an antenna or may down-convert an RF band signal received through an antenna into a baseband signal. For these operations, the wireless communication circuit 310 may include a transmission filter, a reception filter, an amplifier, a mixer, an oscillator, a digital-to-analog converter (DAC), an analog-to-digital converter (ADC), and the like.

According to embodiments, the wireless communication circuit 310 may transmit and receive signals. For example, the wireless communication circuit 310 may transmit a synchronization signal, a reference signal, system information, a message, control information, data, or the like. For example, the RSU 300 may broadcast an OFDM signal to a target vehicle (e.g., the target vehicle 200 in FIG. 1) through the wireless communication circuit 310 and may receive a reflected OFDM signal reflected from the target vehicle.

According to embodiments, the backhaul communication circuit 320 may provide an interface for communication with other nodes in a network. In other words, the backhaul communication circuit 320 may convert a bit string, which is transmitted from the RSU 300 to another node, e.g., another access node, another base station, an upper node, or a core network, into a physical signal and may convert a physical signal received from another node into a bit string.

According to embodiments, the memory 330 may store data, such as a basic program for the operation of the RSU 300, an application program, configuration information, or the like. The memory 330 may include volatile memory, non-volatile memory, or a combination of volatile memory and non-volatile memory.

The control circuit 340 may control operations of the RSU 300. For example, referring to FIG. 1 together, the control circuit 340 may include the discretization error correction circuit 120 and the Kalman filter circuit 130. As another example, the control circuit 340 may transmit and receive signals through the wireless communication circuit 310 or the backhaul communication circuit 320. The control circuit 340 may write data to and read data from the memory 330. For these operations, the control circuit 340 may include at least one processor.

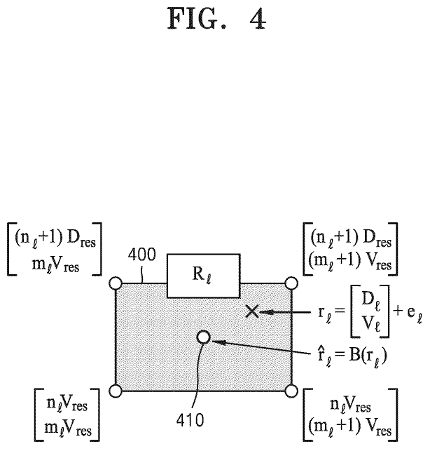

FIG. 4 shows an example of a quantized observation vector according to embodiments.

Referring to FIG. 4, an OFDM signal received by the RSU 300 in a continuous time domain may be given by Equation 5.

$$z ( t ) = \frac{α}{\sqrt{N}} {\sum }_{m = 0}^{M - 1} {\sum }_{n = 0}^{N - 1} s ( n , m ) {e}^{j 2 π {f}_{n} ( t - {mT}_{sym} - {τ}_{ℓ} )} {e}^{j 2 π {f}_{ℓ}^{d} mT} {1}_{{T}_{sym}} ( \frac{t - {mT}_{sym} + {T}_{cp}}{{T}_{sym}} ) \qquad [ Equation 5 ]$$

Here, α is a reflection coefficient, n∈{0,1, . . . , N−1} is a subcarrier index, m∈{0,1, . . . , M−1} is an OFDM symbol index, and s(n, m) is data of an m-th symbol and n-th subcarrier, wherein the data may have a power limit of E[|s(n, m)|²]=1. T, T_{cp}, T_{sym} respectively indicate a symbol length, the length of a cyclic prefix (CP), and the length of an extended OFDM symbol including the CP, wherein T_{sym}=T+T_{cp}. In addition,

$${f}_{n} = \frac{n}{T} = n Δ f ,$$

where Δf is a subcarrier interval, and 1_{A}(x) is an indicator function that takes a value of 1 when an element x is included in set A.

According to embodiments, the received OFDM signal of Equation 5 may be sampled from t=mT_{sym}+kTₛ′, k∈{0,1, . . . , N−1} to

$${T}_{s}^{′} = \frac{T}{K} .$$

At this time, it may be assumed that the propagation delay of a received signal is less than the length of a CP (e.g., [symbol] ≤T_{cp}). A received signal in the discrete time domain may be given by Equation 6.

$$z [ k , m ] = \frac{α}{\sqrt{N}} {\sum }_{n = 0}^{N - 1} s ( n , m ) {e}^{j 2 π {f}_{n} ( \frac{nk}{K} - {f}_{n} {τ}_{ℓ} )} {e}^{j 2 π {f}_{ℓ}^{d} {mT}_{sym}} \\ z [ k , m ] = \frac{α}{\sqrt{N}} {\sum }_{n = 0}^{N - 1} s ( n , m ) {e}^{j 2 π \frac{nk}{K}} {e}^{- j 2 π n {\overline{τ}}_{ℓ}} {e}^{j 2 π m \overline{{f}_{ℓ}^{d}} β} . \qquad [ Equation 6 ]$$

At this time, [symbol] is a normalized propagation delay,

$${\overline{τ}}_{ℓ} = \frac{{τ}_{ℓ}}{T} , \overline{{f}_{ℓ}^{d}}$$

is a normalized Doppler shift,

$$\overline{{f}_{ℓ}^{d}} = \frac{{f}_{ℓ}^{d}}{Δ f} ,$$

and T_{sym}=BT. According to embodiments, the received OFDM sample of Equation 6 may be given by Equation 7.

$${Z}_{KM} = α {W}_{N}^{- I} {H}_{N}^{*} ( {\overline{τ}}_{ℓ} ) {SH}_{M} ( \overline{{f}_{ℓ}^{d}} β ) . \qquad [ Equation 7 ]$$

At this time, W_{N}∈ [symbol] ^{N×N} is an N-point discrete Fourier transform (DFT) matrix, W_{N}⁻¹=W_{N}*, S is a data matrix having s(n, m) as an element, and H_{N}(α)=diag[1, e^{j2πα}, . . . , e^{j2π(N-1)α}] is a diagonal matrix. [symbol] is a complex number. S in Equation 7 interferes with the extraction of distance and relative velocity information and may thus be removed after Equation 7 is converted into a frequency domain, which is given by Equation 8.

$$\begin{matrix}{Z}_{F M} = {W}_{N} {Z}_{K M} ∅ S \\ = α {H}_{N}^{*} ( {\overline{τ}}_{ℓ} ) {1}_{N * M} {H}_{M} ( \overline{{f}_{ℓ}^{d}} β ) \\ = α {H}_{N}^{*} ( {\overline{τ}}_{ℓ} ) {1}_{N} {1}_{M}^{T} {H}_{M} ( \overline{{f}_{ℓ}^{d}} β ) \\ = α {h}_{N}^{*} ( {\overline{τ}}_{ℓ} ) {h}_{M}^{T} ( \overline{{f}_{ℓ}^{d}} β ) .\end{matrix} \qquad [ Equation 8 ]$$

Here, H_{M} [symbol] β)ØS is due to the commutative law, Ø represents element-wise division, and h_{N}(m)=H_{N}(m)1_{N}∈ [symbol] ^{N}.

A propagation delay and the Doppler shift may respectively change the phase an OFDM subcarrier and the phase of a symbol. Accordingly, extraction of the propagation delay and the Doppler shift is equivalent or similar to spectrum estimation. Accordingly, multiplication of N-size inverse DFT (IDFT) may be performed to extract propagation delay on a frequency axis and multiplication of M-size DFT may be performed to extract Doppler shift on a time axis, which may be given by Equation 9.

$$\begin{matrix}{Z}_{DV} = {W}_{N}^{- 1} {Z}_{F M} {W}_{M} \\ = α {u}_{N}^{*} ( {\overline{τ}}_{ℓ} ) {u}_{M}^{T} ( \overline{{f}_{ℓ}^{d}} β ) .\end{matrix} \qquad [ Equation 9 ]$$

At this time, u_{N}(m)=W_{N}h_{N}(m)∈ [symbol] ^{N} and is a vector that has a peak value at an m-th index. For example, the index may be based on a constant false alarm rate (CFAR) algorithm. The index of a maximum value (or highest value) corresponding to propagation delay may be converted into a distance and the index of a maximum value (or highest value) corresponding to Doppler shift may be converted into a relative velocity. At this time, an OFDM system may obtain a result of discrete observation because the OFDM system is designed based on digital signal processing.

To express the result of discrete observation, a discretization operator may be applied to a continuous observation vector. In general, a continuous observation vector at an [symbol] th discrete time in a radar system may be given by Equation 10.

$${r}_{ℓ} = g ( {t}_{ℓ} ) + {e}_{ℓ} . \qquad [ Equation 10 ]$$

At this time, [symbol] =[ [symbol] , [symbol] ]^{T}∈ [symbol] ² is an observation vector including a distance and a relative velocity and [symbol] =[ [symbol] , [symbol] ]^{T}∈ [symbol] ² is observation noise and follows a Gaussian distribution having mean 0 and variance Qₙ. Qₙ=diag[σ_{D}², σ_{V}²]∈ [symbol] ^{2×2} and corresponds to non-linear transformation of g ( [symbol] )=[ [symbol] ( [symbol] ), [symbol] ( [symbol] )]^{T}.

$${\hat{r}}_{ℓ} = B ( {r}_{ℓ} ) = B ( g ( {t}_{ℓ} ) + {e}_{ℓ} ) = [ \begin{matrix}{n}_{ℓ} {D}_{r e s} + \frac{{D}_{r e s}}{2} \\ {m}_{ℓ} {V}_{r e s} + \frac{{V}_{r e s}}{2}\end{matrix} ] . \qquad [ Equation 11 ]$$

At this time, B(⋅) is a discretization operator,

$${n}_{ℓ} = ⌊ \frac{{r}_{{D}_{ℓ}}}{{D}_{r e s}} ⌋ ( {D}_{r e s} = \frac{{D}_{max}}{N} = \frac{{c}_{0}}{2 Δ fN} ) ,$$

and

$${m}_{ℓ} = ⌊ \frac{{r}_{{V}_{ℓ}}}{{V}_{r e s}} ⌋ ( {V}_{r e s} = \frac{{V}_{max}}{M} = \frac{{c}_{0}}{2 {f}_{c} {T}_{sym} M} ) .$$

A rectangular region 400 at the [symbol] -th discrete time generated by discrete observation may be defined as Equation 12.

$$= \{ ( {r}_{{D}_{ℓ}} , {r}_{{V}_{ℓ}} ) \vert {n}_{ℓ} {D}_{r e s} \leq {r}_{{D}_{ℓ}} < ( {n}_{ℓ} + 1 ) {D}_{r e s} , {m}_{ℓ} {V}_{r e s} \leq {r}_{{V}_{ℓ}} \leq ( {m}_{ℓ} + 1 ) {V}_{r e s} \} . \qquad [ Equation 12 ]$$

According to embodiments, the result of the discretization operator in Equation 11 indicates a center point 410 of the rectangular region 400. In other words, according to the result of using the discretization operator B(⋅) in Equation 11, the real position and relative velocity of the target vehicle 200 may correspond to an arbitrary spot in the rectangular region 400, but the position and relative velocity of the target vehicle 200 may be always observed according to the center point 410 of the rectangular region 400 and thus always contain a discretization error.

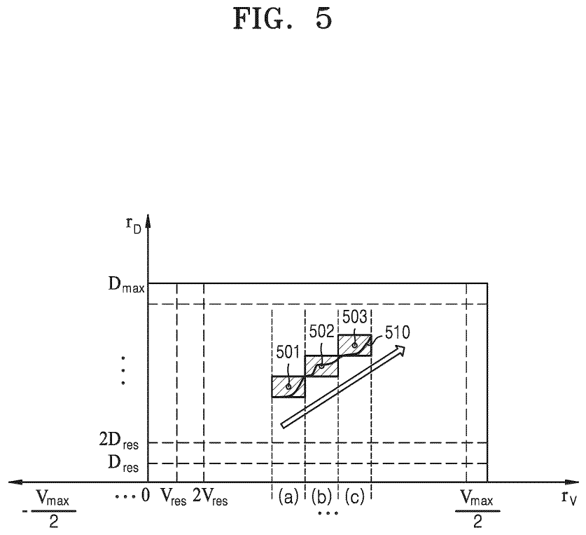

FIG. 5 shows an example in which a quantized observation vector moves according to the movement of the target vehicle 200, according to embodiments.

Referring to FIG. 5, a non-linear trajectory 510 may correspond to a continuous observation vector in the discrete time of the target vehicle 200. A center point 501 may correspond to a rectangular region at an ( [symbol] −1)-th discrete time generated by discrete observation in section (a). In section (a), the continuous observation vector of the target vehicle 200 may correspond to section (a) of the non-linear trajectory 510. However, when the continuous observation vector is transformed into a discrete observation vector by using a discretization operator according to Equation 11, the discrete observation vector of the target vehicle 200 may always appear as the center point 501 in section (a). A center point 502 may correspond to a rectangular region at an [symbol] -th discrete time generated by discrete observation in section (b). In section (b), the continuous observation vector of the target vehicle 200 may correspond to section (b) of the non-linear trajectory 510. However, when the continuous observation vector is transformed into a discrete observation vector by using a discretization operator according to Equation 11, the discrete observation vector of the target vehicle 200 may always appear as the center point 502 in section (b). A center point 503 may correspond to a rectangular region at an ( [symbol] +1)-th discrete time generated by discrete observation in section (c). In section (c), the continuous observation vector of the target vehicle 200 may correspond to section (c) of the non-linear trajectory 510. However, when the continuous observation vector is transformed into a discrete observation vector by using a discretization operator according to Equation 11, the discrete observation vector of the target vehicle 200 may always appear as the center point 503 in section (c).

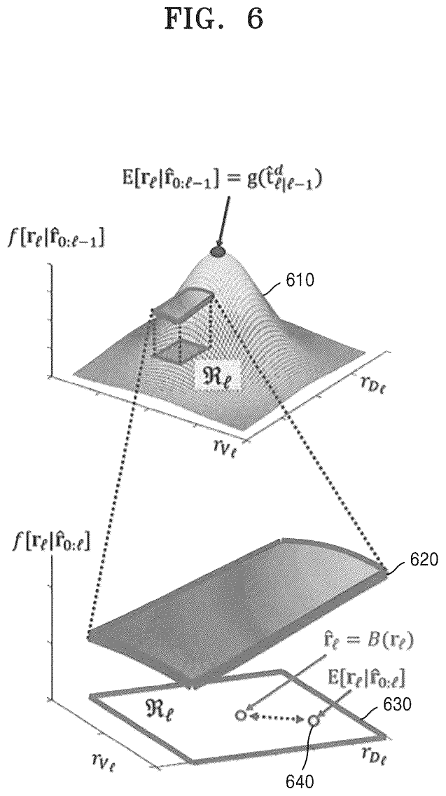

FIG. 6 shows an example of a conditional observation probability density function according to embodiments.

In the case of a tracking algorithm using a Kalman filter according to the related art, infinite resolution, e.g., a DFT matrix of an infinite size, is required (or used) to obtain a continuous observation vector. In reality, it is impossible to obtain infinite bandwidth in the frequency domain and infinite data symbols in the time domain. Accordingly, a finite-resolution scenario according to embodiments may update a state vector and a covariance matrix, based on the discrete observation vector [symbol] .

According to a comparative example, a vehicle tracking algorithm according to the related art may be based on an EKF. For example, when a previous predicted state vector [symbol] =E[ [symbol] | [symbol] ] and a previous predicted covariance matrix [symbol] =E[( [symbol] − [symbol] )( [symbol] − [symbol] )^{T}| [symbol] ] are given, a predicted state vector and a covariance matrix based on the linear state-space model of Equation 4 may be given by Equation 13.

$${\hat{t}}_{ℓ \vert ℓ - 1} = E [ {t}_{ℓ} \vert {r}_{0 : ℓ - 1} ] = A {\hat{t}}_{ℓ - 1} \qquad [ Equation 13 ]$$

$${\hat{Q}}_{ℓ \vert ℓ - 1} = E [ ( {t}_{ℓ} - {\hat{t}}_{ℓ \vert ℓ - 1} ) {( {t}_{ℓ} - {\hat{t}}_{ℓ \vert ℓ - 1} )}^{T} \vert {r}_{0 : ℓ - 1} ] = A {\hat{Q}}_{ℓ - 1} {A}^{T} + {Q}_{ω} .$$

A Kalman filter algorithm may not be directly used because there is a non-linear relationship between an observation vector and a state vector. Equation 10 may be linearized using first-order Taylor approximation, which may be given by Equation 14.

$$g ( {t}_{ℓ} ) ≅ g ( {\hat{t}}_{ℓ \vert ℓ - 1} ) + {J}_{ℓ \vert ℓ - 1} ( {t}_{ℓ} - {\hat{t}}_{ℓ \vert ℓ - 1} ) . \qquad [ Equation 14 ]$$

Here, [symbol] ∈ [symbol] ^{2×2} is a Jacobian matrix, which is given by Equation 15. According to embodiments, the Jacobian matrix may be a matrix of partial derivatives of a non-linear transformation of a state vector (e.g., a first state vector).

$${{{J}_{ℓ \vert ℓ - 1} = \frac{\partial g ( {t}_{ℓ} )}{\partial t} \vert}_{t = {\hat{t}}_{ℓ \vert ℓ - 1}} = [ \begin{matrix}\frac{\partial {D}_{ℓ}}{\partial {x}_{ℓ}} \\ \frac{\partial {V}_{ℓ}}{\partial {x}_{ℓ}}\end{matrix} ] [ \frac{\partial {x}_{ℓ}}{\partial {x}_{ℓ}} , \frac{\partial {x}_{ℓ}}{\partial {v}_{ℓ}} ] \vert}_{t = {\hat{t}}_{ℓ \vert ℓ - 1}} = [ \text{} \begin{matrix}\frac{{\hat{x}}_{ℓ \vert ℓ - 1} - X}{\sqrt{{( {\hat{x}}_{ℓ \vert ℓ - 1} - X )}^{2} + {( {\hat{x}}_{ℓ \vert ℓ - 1} - Y )}^{2} + {h}^{2}}} \\ \frac{{\hat{v}}_{ℓ \vert ℓ - 1} ( ( y - Y ) + {h}^{2} )}{{( {( {\hat{x}}_{ℓ \vert ℓ - 1} - X )}^{2} + {( {\hat{x}}_{ℓ \vert ℓ - 1} - Y )}^{2} + {h}^{2} )}^{\frac{3}{2}}}\end{matrix} ] [ 1 , {T}_{s} ] . \qquad [ Equation 15 ]$$

A state vector and a covariance matrix, which are updated at the [symbol] -th discrete time by using the discrete observation vector [symbol] , are given by Equations 16 and 17.

$${\hat{t}}_{ℓ}^{B} = {\hat{t}}_{ℓ \vert ℓ - 1}^{B} + {K}_{ℓ}^{B} ( {\hat{r}}_{ℓ} - g ( {\hat{t}}_{ℓ \vert ℓ - 1}^{B} ) ) \qquad [ Equation 16 ]$$

$${\hat{Q}}_{ℓ}^{B} = ( {I}_{2} - {K}_{ℓ}^{B} \vert {J}_{ℓ \vert ℓ - 1}^{B} ) {\hat{Q}}_{ℓ \vert ℓ - 1}^{B} . \qquad [ Equation 17 ]$$

However, as described above with reference to FIG. 5, even when the target vehicle 200 is traveling, the RSU 100 may not detect changes in distance and velocity information because the RSU 100 inevitably identifies resolution (e.g., the state vector of the target vehicle 200 in the rectangular region 400 in FIG. 4) as being fixed (e.g., the center point 410 of the rectangular region 400 in FIG. 4), and accordingly, there may be a challenge in a vehicle tracking algorithm because a discretization error is not resolved in a lower-resolution scenario.

Referring to FIG. 6, a discrete-time conditional prior probability density function 610, a discrete-time conditional posterior probability density function 620, and a conditional posterior probability density function 630 of a normal distribution are illustrated.

A prior probability density function at the [symbol] -th discrete time is a non-linear function and may thus be approximated by the Gaussian distribution according to Equation 18.

$$f [ {t}_{ℓ} \vert {\hat{r}}_{0 : ℓ - 1} ] \approx 𝒩 ( {\hat{t}}_{ℓ \vert ℓ - 1}^{d} , {\hat{Q}}_{ℓ \vert ℓ - 1}^{d} ) . \qquad [ Equation 18 ]$$

To derive an updated state vector by using the discrete observation vector [symbol] at the [symbol] -th discrete time, a state vector definition may be used as shown in Equation 19.

$$\begin{matrix}{\hat{t}}_{ℓ}^{d} = E [ {t}_{ℓ} \vert {\hat{r}}_{0 : ℓ} ] \\ = E [ {t}_{ℓ} \vert {\hat{r}}_{0 : ℓ - 1} , {\hat{r}}_{ℓ} ] \\ = {\int }_{{ℝ}^{2}} {t}_{ℓ} f [ {t}_{ℓ} \vert {\hat{r}}_{0 : ℓ - 1} , {\hat{r}}_{ℓ} ] {dt}_{ℓ} \\ = {\int }_{{ℝ}^{2}} {t}_{ℓ} [ {\int }_{{r}_{ℓ} ∈ {ℜ}_{ℓ}} \frac{f [ {t}_{ℓ} , {r}_{ℓ} \vert {\hat{r}}_{0 : ℓ - 1} ]}{Pr [ {\hat{r}}_{ℓ} \vert {\hat{r}}_{0 : ℓ - 1} ]} {dr}_{ℓ} ] {dt}_{ℓ}\end{matrix} . \qquad [ Equation 19 ]$$

Here, Equation 19 may be derived based on Pr[ [symbol] | [symbol] ]= [symbol] f[ [symbol] | [symbol] ] [symbol] representing Bayes' rule. Equation 19 may be rewritten as Equation 20.

$$\begin{matrix}{\int }_{{ℝ}^{2}} {t}_{ℓ} [ {\int }_{{r}_{ℓ} ∈ {ℜ}_{ℓ}} \frac{f [ {t}_{ℓ} , {r}_{ℓ} \vert {\hat{r}}_{0 : ℓ - 1} ]}{Pr [ {\hat{r}}_{ℓ} \vert {\hat{r}}_{0 : ℓ - 1} ]} {dr}_{ℓ} ] {dt}_{ℓ} = {\int }_{{ℝ}^{2}} {t}_{ℓ} [ {\int }_{{r}_{ℓ} ∈ {ℜ}_{ℓ}} \frac{f [ {t}_{ℓ} , {r}_{ℓ} \vert {\hat{r}}_{0 : ℓ - 1} ]}{f [ {r}_{ℓ} \vert {\hat{r}}_{0 : ℓ - 1} ]} \frac{f [ {r}_{ℓ} \vert {\hat{r}}_{0 : ℓ - 1} ]}{Pr [ {\hat{r}}_{ℓ} \vert {\hat{r}}_{0 : ℓ - 1} ]} {dr}_{ℓ} ] {dt}_{ℓ} \\ = {\int }_{{r}_{ℓ} ∈ {ℜ}_{ℓ}} [ {\int }_{{ℝ}^{2}} {t}_{ℓ} f [ {t}_{ℓ} \vert {\hat{r}}_{0 : ℓ - 1} , {r}_{ℓ} ] {dt}_{ℓ} ] \frac{f [ {r}_{ℓ} \vert {\hat{r}}_{0 : ℓ - 1} ]}{Pr [ {\hat{r}}_{ℓ} \vert {\hat{r}}_{0 : ℓ - 1} ]} {dr}_{ℓ} \\ = {\int }_{{r}_{ℓ} ∈ {ℜ}_{ℓ}} [ {\int }_{{ℝ}^{2}} {t}_{ℓ} f [ {t}_{ℓ} \vert {\hat{r}}_{0 : ℓ - 1} , {r}_{ℓ} ] {dt}_{ℓ} ] f [ {r}_{ℓ} \vert {\hat{r}}_{0 : ℓ} ] {dr}_{ℓ} \\ = {\int }_{{r}_{ℓ} ∈ {ℜ}_{ℓ}} E [ {t}_{ℓ} \vert {\hat{r}}_{0 : ℓ - 1} , {r}_{ℓ} ] f [ {r}_{ℓ} \vert {\hat{r}}_{0 : ℓ} ] {dr}_{ℓ} \\ = {\int }_{{r}_{ℓ} ∈ {ℜ}_{ℓ}} {\hat{t}}_{ℓ \vert ℓ - 1}^{d} + {K}_{ℓ}^{d} ( {r}_{ℓ} - g ( {\hat{t}}_{ℓ \vert ℓ - 1}^{d} ) ) f [ {r}_{ℓ} \vert {\hat{r}}_{0 : ℓ} ] {dr}_{ℓ}\end{matrix} . \qquad [ Equation 20 ]$$

Equation 20 uses the updated state vector of a tracking algorithm based on an EKF under the assumption of Equation 18, and the updated state vector and covariance matrix of the EKF may be respectively given by Equations 21 and 22.

$${\hat{t}}_{ℓ} = {\hat{t}}_{ℓ \vert ℓ - 1} + {K}_{ℓ} ( {r}_{ℓ} - g ( {\hat{t}}_{ℓ \vert ℓ - 1} ) ) \qquad [ Equation 21 ]$$

$${\hat{Q}}_{ℓ} = ( {I}_{2} - {K}_{ℓ} {J}_{ℓ \vert ℓ - 1} ) {\hat{Q}}_{ℓ \vert ℓ - 1} . \qquad [ Equation 22 ]$$

Here, [symbol] is the Kalman gain matrix and [symbol] = [symbol] ₋₁( [symbol] )^{T}( [symbol] [symbol] ₋₁( [symbol] )^{T}+Qₙ)⁻¹∈ [symbol] ^{2×2}. Equation 20 may be rewritten as Equation 23.

$${\int }_{{r}_{ℓ} ∈ {ℜ}_{ℓ}} {\hat{t}}_{ℓ \vert ℓ - 1}^{d} + {K}_{ℓ}^{d} ( {r}_{ℓ} - g ( {\hat{t}}_{ℓ \vert ℓ - 1}^{d} ) ) f [ {r}_{ℓ} \vert {\hat{r}}_{0 : ℓ} ] {dr}_{ℓ} = {\hat{t}}_{ℓ \vert ℓ - 1}^{d} + {K}_{ℓ}^{d} ( {\int }_{{r}_{ℓ} ∈ {ℜ}_{ℓ}} {r}_{ℓ} f [ {r}_{ℓ} \vert {\hat{r}}_{0 : ℓ} ] {dr}_{ℓ} - g ( {\hat{t}}_{ℓ \vert ℓ - 1}^{d} ) ) . \qquad [ Equation 23 ]$$

Equation 23 may be established because [symbol] and g( [symbol] ) are not functions of an observation vector. Equation 23 may be rewritten as Equation 24.

$${\hat{t}}_{ℓ \vert ℓ - 1}^{d} + {K}_{ℓ}^{d} ( {\int }_{{r}_{ℓ} ∈ {ℜ}_{ℓ}} {r}_{ℓ} f [ {r}_{ℓ} \vert {\hat{r}}_{0 : ℓ} ] {dr}_{ℓ} - g ( {\hat{t}}_{ℓ \vert ℓ - 1}^{d} ) ) = {\hat{t}}_{ℓ \vert ℓ - 1}^{d} + {K}_{ℓ}^{d} ( E [ {r}_{ℓ} \vert {\hat{r}}_{0 : ℓ} ] - g ( {\hat{t}}_{ℓ \vert ℓ - 1}^{d} ) ) . \qquad [ Equation 24 ]$$

The Kalman gain matrix [symbol] in Equation 24 may be given by Equation 25.

$$[ Equation 25 ]$$

$${K}_{ℓ}^{d} = {{\hat{Q}}_{ℓ \vert ℓ - 1}^{d} ( {J}_{ℓ \vert ℓ - 1}^{d} )}^{T} {( {J}_{ℓ \vert ℓ - 1}^{d} {{\hat{Q}}_{ℓ \vert ℓ - 1}^{d} ( {J}_{ℓ \vert ℓ - 1}^{d} )}^{T} + {Q}_{n} )}^{- 1} ∈ {ℝ}^{2 x 2} .$$

According to a derivation process similar to that described above, the covariance matrix may be given by Equation 26.

$$[ Equation 26 ]$$

$$\begin{matrix}{\hat{Q}}_{ℓ}^{d} \dot{=} E [ ( {t}_{ℓ} - {\hat{t}}_{ℓ}^{d} ) {( {t}_{ℓ} - {\hat{t}}_{ℓ}^{d} )}^{T} \vert {\hat{r}}_{0 : ℓ} ] \\ = E [ ( {t}_{ℓ} - {\hat{t}}_{ℓ}^{d} ) {( {t}_{ℓ} - {\hat{t}}_{ℓ}^{d} )}^{T} \vert {\hat{r}}_{0 : ℓ - 1} , {\hat{r}}_{ℓ} ] \\ {=}^{( a )} E [ E ( {t}_{ℓ} - {\hat{t}}_{ℓ}^{d} ) {( {t}_{ℓ} - {\hat{t}}_{ℓ}^{d} )}^{T} \vert {\hat{r}}_{0 : ℓ - 1} , {\hat{r}}_{ℓ} = {r}_{ℓ} ] \vert {\hat{r}}_{0 : ℓ - 1} , {\hat{r}}_{ℓ} ] \\ = E [ E [ ( {\underbrace{{t}_{ℓ} - ( {\hat{t}}_{ℓ \vert ℓ - 1}^{d} + {K}_{ℓ}^{d} ( E [ {r}_{ℓ} \vert {\hat{r}}_{0 : ℓ} ] - g ( {\hat{t}}_{ℓ \vert ℓ - 1}^{d} ) ) )}}_{▲} ) {( ▲ )}^{T} \vert {\hat{r}}_{0 : ℓ - 1} , {\hat{r}}_{ℓ} = {r}_{ℓ} ] \vert {\hat{r}}_{0 : ℓ - 1} , {\hat{r}}_{ℓ} ] \\ = E [ E [ ( {\underbrace{{t}_{ℓ} - ( {\hat{t}}_{ℓ \vert ℓ - 1}^{d} + {K}_{ℓ}^{d} ( {r}_{ℓ} - g ( {\hat{t}}_{ℓ \vert ℓ - 1}^{d} ) ) ) + {K}_{ℓ}^{d} ( {r}_{ℓ} - E [ {r}_{ℓ} \vert {\hat{r}}_{0 : ℓ} ] )}}_{▼} ) {( ▼ )}^{T} \vert {\hat{r}}_{0 : ℓ - 1} , {\hat{r}}_{ℓ} = {r}_{ℓ} ] \vert {\hat{r}}_{0 : ℓ} ] \\ {=}^{( b )} E [ E [ ( {t}_{ℓ} - ( {\hat{t}}_{ℓ \vert ℓ - 1}^{d} + {K}_{ℓ}^{d} ( {r}_{ℓ} - g ( {\hat{t}}_{ℓ \vert ℓ - 1}^{d} ) ) ) ) {( {t}_{ℓ} - ( {\hat{t}}_{ℓ \vert ℓ - 1}^{d} + {K}_{ℓ}^{d} ( {r}_{ℓ} - g ( {\hat{t}}_{ℓ \vert ℓ - 1}^{d} ) ) ) )}^{T} \vert {r}_{0 : ℓ - 1} , {\hat{r}}_{ℓ} = {r}_{ℓ} ] \vert {\hat{r}}_{0 : ℓ} ] + \\ E [ E [ ( {t}_{ℓ} - ( {\hat{t}}_{ℓ \vert ℓ - 1}^{d} + {K}_{ℓ}^{d} ( {r}_{ℓ} - g ( {\hat{t}}_{ℓ \vert ℓ - 1}^{d} ) ) ) ) {( {K}_{ℓ}^{d} ( {r}_{ℓ} - E [ {r}_{ℓ} \vert {\hat{r}}_{0 : ℓ} ] ) )}^{T} \vert {\hat{r}}_{0 : ℓ - 1} , {\hat{r}}_{ℓ} = {r}_{ℓ} ] \vert {\hat{r}}_{0 : ℓ} ] + \\ E [ E [ ( {K}_{ℓ}^{d} ( {r}_{ℓ} - E [ {r}_{ℓ} \vert {\hat{r}}_{0 : ℓ} ] ) ) {( {t}_{ℓ} - ( {\hat{t}}_{ℓ \vert ℓ - 1}^{d} + {K}_{ℓ}^{d} ( {r}_{ℓ} - g ( {\hat{t}}_{ℓ \vert ℓ - 1}^{d} ) ) ) )}^{T} \vert {\hat{r}}_{0 : ℓ - 1} , {\hat{r}}_{ℓ} = {r}_{ℓ} ] \vert {\hat{r}}_{0 : ℓ} ] + \\ E [ E [ ( {K}_{ℓ}^{d} ( {r}_{ℓ} - E [ {r}_{ℓ} \vert {\hat{r}}_{0 : ℓ} ] ) ) {( {K}_{ℓ}^{d} ( {r}_{ℓ} - E [ {r}_{ℓ} \vert {\hat{r}}_{0 : ℓ} ] ) )}^{T} \vert {\hat{r}}_{0 : ℓ - 1} , {\hat{r}}_{ℓ} = {r}_{ℓ} ] \vert {\hat{r}}_{0 : ℓ} ] \\ {=}^{( c )} E [ ( {I}_{2} - {K}_{ℓ}^{d} {J}_{ℓ \vert ℓ - 1}^{d} ) {\hat{Q}}_{ℓ \vert ℓ - 1}^{d} \vert {\hat{r}}_{0 : ℓ} ] + E [ {K}_{ℓ}^{d} ( {r}_{ℓ} - E [ {r}_{ℓ} \vert {\hat{r}}_{0 : ℓ} ] ) {( {r}_{ℓ} - E [ {r}_{ℓ} \vert {\hat{r}}_{0 : ℓ} ] )}^{T} {( {K}_{ℓ}^{d} )}^{T} \vert {\hat{r}}_{0 : ℓ} ] \\ {=}^{( d )} ( {I}_{2} - {K}_{ℓ}^{d} {J}_{ℓ \vert ℓ - 1}^{d} ) {\hat{Q}}_{ℓ \vert ℓ - 1}^{d} + {K}_{ℓ}^{d} cov [ {r}_{ℓ} \vert {r}_{0 : ℓ} ] {( {K}_{ℓ}^{d} )}^{T} .\end{matrix} \qquad ( 13 )$$

Here, (a) may be established based on the law of total expectation, (b) may be established because component [symbol] (E[ [symbol] | [symbol] ]−g( [symbol] )) in the second and third terms in (b) is irrelevant to inner expectation, and (c) may be calculated based on the covariance matrix of Equation 22.

According to embodiments, the [symbol] th discrete-time conditional posterior probability density function 620 may be expressed as the [symbol] -th discrete-time conditional prior probability density function 610, as shown in Equation 27.

$$[ Equation 27 ]$$

$$f [ {r}_{ℓ} \vert {\hat{r}}_{0 : ℓ} ] = \frac{f [ {r}_{ℓ} \vert {\hat{r}}_{0 : ℓ - 1} ]}{Pr [ {\hat{r}}_{ℓ} \vert {\hat{r}}_{0 : ℓ - 1} ]} {1}_{{ℛ}_{ℓ}} ( {r}_{ℓ} ) .$$

The [symbol] -th discrete-time conditional prior probability density function 610 may be rewritten as Equation 28, based on the approximation of the probability density function of Equation 19.

$$[ Equation 28 ]$$

$$f [ {r}_{ℓ} \vert {\hat{r}}_{0 : ℓ - 1} ] = 𝒩 ( g ( {\hat{t}}_{ℓ \vert ℓ - 1}^{d} ) , {P}_{ℓ} ) .$$

At this time, [symbol] = [symbol] [symbol] ( [symbol] )^{T}+Qₙ∈ [symbol] ^{2×2}.

A mean vector 640 of the conditional posterior probability density function 630 of a normal distribution (e.g., the mean vector of the normal distribution into which the conditional posterior probability density function has been transformed) representing the statistical characteristic of an observation vector may be given by Equation 29.

$$[ Equation 29 ]$$

$$E [ {r}_{ℓ} \vert {\hat{r}}_{0 : ℓ} ] = [ \begin{matrix}E [ {r}_{{D}_{ℓ}} \vert {\hat{r}}_{0 : ℓ} ] \\ E [ {r}_{{D}_{ℓ}} \vert {\hat{r}}_{0 : ℓ} ]\end{matrix} ] [ \begin{matrix}{\hat{D}}_{ℓ \vert ℓ - 1}^{d} + \frac{ϕ ( {ζ}_{ℓ}^{L} ) - ϕ ( {ζ}_{ℓ}^{U} )}{Φ ( {ζ}_{ℓ}^{U} ) - Φ ( {ζ}_{ℓ}^{L} )} \sqrt{{P}_{ℓ}} \\ {\hat{V}}_{ℓ \vert ℓ - 1}^{d} + \frac{Φ ( {η}_{ℓ}^{U} ) - Φ ( {η}_{ℓ}^{L} )}{ϕ ( {η}_{ℓ}^{L} ) - ϕ ( {η}_{ℓ}^{U} )} \sqrt{{P}_{ℓ}}\end{matrix} ] .$$

Here,

$$ϕ ( x ) = \frac{1}{\sqrt{2} π} exp ( - \frac{1}{2} {x}^{2} ) , Φ ( x ) = {\int }_{- ∞}^{x} ϕ ( a ) d a ,$$

and the arguments of the distribution may be defined as Equations 30 to 34.

$$[ Equation 30 ]$$

$${ζ}_{ℓ}^{L} = \frac{B ( {D}_{ℓ} ) - \frac{{D}_{res}}{2} - {\hat{D}}_{ℓ \vert ℓ - 1}^{d}}{\sqrt{{P}_{ℓ}}}$$

$$[ Equation 31 ]$$

$${ζ}_{ℓ}^{U} = \frac{B ( {D}_{ℓ} ) + \frac{{D}_{res}}{2} - {\hat{D}}_{ℓ \vert ℓ - 1}^{d}}{\sqrt{{P}_{ℓ}}}$$

$$[ Equation 32 ]$$

$${η}_{ℓ}^{L} = \frac{B ( {V}_{ℓ} ) - \frac{{V}_{res}}{2} - {\hat{V}}_{ℓ \vert ℓ - 1}^{d}}{\sqrt{{P}_{ℓ}}}$$

$$[ Equation 33 ]$$

$${η}_{ℓ}^{U} = \frac{B ( {V}_{ℓ} ) + \frac{{V}_{r e s}}{2} - {\hat{V}}_{ℓ \vert ℓ - 1}^{d}}{\sqrt{{P}_{ℓ}}}$$

The covariance (e.g., the covariance matrix) of the conditional posterior probability density function 630 of a normal distribution (e.g., the covariance of the normal distribution into which the conditional posterior probability density function has been transformed) representing the statistical characteristic of an observation vector may be given by Equation 34.

$$[ Equation 34 ]$$

$$cov [ {r}_{ℓ} \vert {\hat{r}}_{0 : ℓ} ] = [ \begin{matrix}var [ {r}_{{D}_{ℓ}} \vert {\hat{r}}_{0 : ℓ} ] & 0 \\ 0 & var [ {r}_{{V}_{ℓ}} \vert {\hat{r}}_{0 : ℓ} ]\end{matrix} ]$$

At this time, the variance of distance and relative velocity may be defined as Equation 35.

$$[ Equation 35 ]$$

$$var [ {r}_{{D}_{ℓ}} \vert {\hat{r}}_{0 : ℓ} ] = {P}_{ℓ} ( 1 + \frac{{ζ}_{ℓ}^{L} ϕ ( {ζ}_{ℓ}^{L} ) - {ζ}_{ℓ}^{U} ϕ ( {ζ}_{ℓ}^{U} )}{Φ ( {ζ}_{ℓ}^{U} ) - Φ ( {ζ}_{ℓ}^{L} )} ) - {{P}_{ℓ} ( \frac{ϕ ( {ζ}_{ℓ}^{L} ) - ϕ ( {ζ}_{ℓ}^{U} )}{Φ ( {ζ}_{ℓ}^{U} ) - Φ ( {ζ}_{ℓ}^{L} )} )}^{2} \\ var [ {r}_{{V}_{ℓ}} \vert {\hat{r}}_{0 : ℓ} ] = {P}_{ℓ} ( 1 + \frac{{η}_{ℓ}^{L} ϕ ( {η}_{ℓ}^{L} ) - {η}_{ℓ}^{U} ϕ ( {η}_{ℓ}^{U} )}{Φ ( {η}_{ℓ}^{U} ) - Φ ( {η}_{ℓ}^{L} )} ) - {{P}_{ℓ} ( \frac{ϕ ( {η}_{ℓ}^{L} ) - ϕ ( {η}_{ℓ}^{U} )}{Φ ( {η}_{ℓ}^{U} ) - Φ ( {η}_{ℓ}^{L} )} )}^{2}$$

When Equations 29 and 34 are respectively applied to Equation 24 and Equation 26 (d), the updated state vector and the covariance matrix may be respectively given by Equations 36 and 37, respectively.

$$[ Equation 36 ]$$

$${\hat{t}}_{ℓ}^{d} = {\hat{t}}_{ℓ \vert ℓ - 1}^{d} + {K}_{ℓ}^{d} ( {λ}_{ℓ}^{d} )$$

$$[ Equation 37 ]$$

$${\hat{Q}}_{ℓ} = ( {1}_{2} - {Λ}_{ℓ}^{d} {K}_{ℓ} {J}_{ℓ \vert ℓ - 1} ) {\hat{Q}}_{ℓ \vert ℓ - 1}$$

At this time, [symbol] in Equation 36 is a state correction factor in the update process and may be given by Equation 38 and [symbol] in Equation 37 is a covariance correction factor in the update process and may be given by Equation 39.

$$[ Equation 38 ]$$

$${λ}_{ℓ}^{d} = [ \begin{matrix}{λ}_{{D}_{ℓ}}^{d} \\ {λ}_{{V}_{ℓ}}^{d}\end{matrix} ] = [ \begin{matrix}\frac{ϕ ( {ζ}_{ℓ}^{L} ) - ϕ ( {ζ}_{ℓ}^{U} )}{Φ ( {ζ}_{ℓ}^{U} ) - Φ ( {ζ}_{ℓ}^{L} )} \sqrt{{P}_{ℓ}} \\ \frac{ϕ ( {η}_{ℓ}^{L} ) - ϕ ( {η}_{ℓ}^{U} )}{Φ ( {η}_{ℓ}^{U} ) - Φ ( {η}_{ℓ}^{L} )} \sqrt{{P}_{ℓ}}\end{matrix} ] ∈ {ℝ}^{2}$$

$$[ Equation 39 ]$$

$${Λ}_{ℓ}^{d} = diag [ {Λ}_{{D}_{ℓ}}^{d} , {Λ}_{{V}_{ℓ}}^{d} ] = diag [ {( \frac{ϕ ( {ζ}_{ℓ}^{L} ) - ϕ ( {ζ}_{ℓ}^{U} )}{Φ ( {ζ}_{ℓ}^{U} ) - Φ ( {ζ}_{ℓ}^{L} )} )}^{2} - \frac{{ζ}_{ℓ}^{L} ϕ ( {ζ}_{ℓ}^{L} ) - {ζ}_{ℓ}^{U} ϕ ( {ζ}_{ℓ}^{U} )}{Φ ( {ζ}_{ℓ}^{U} ) - Φ ( {ζ}_{ℓ}^{L} )} , {( \frac{ϕ ( {η}_{ℓ}^{L} ) - ϕ ( {η}_{ℓ}^{U} )}{Φ ( {η}_{ℓ}^{U} ) - Φ ( {η}_{ℓ}^{L} )} )}^{2} - \frac{{η}_{ℓ}^{L} ϕ ( {η}_{ℓ}^{L} ) - {η}_{ℓ}^{U} ϕ ( {η}_{ℓ}^{U} )}{Φ ( {η}_{ℓ}^{U} ) - Φ ( {η}_{ℓ}^{L} )} ] ∈ {ℝ}^{2 * 2}$$

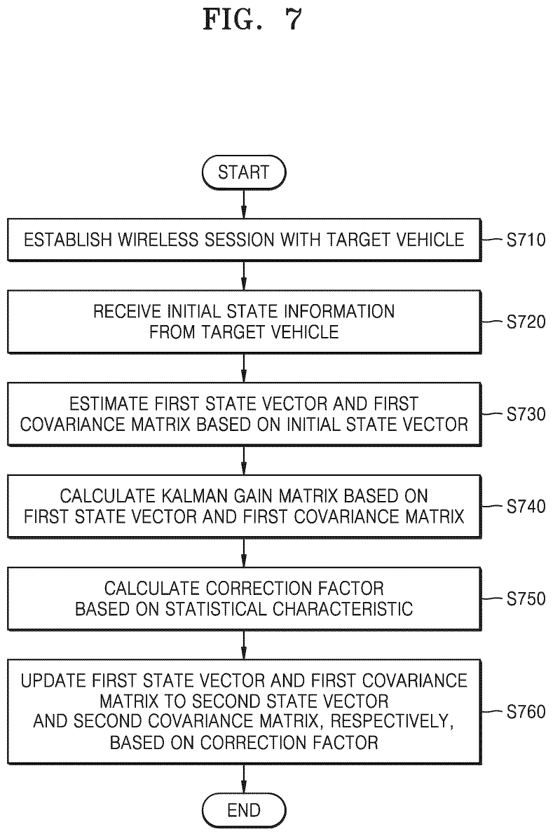

FIG. 7 is a flowchart of an operating method of the RSU 100, according to embodiments.

Referring to FIG. 7, the RSU 100 may establish a wireless session with a target vehicle (e.g., the target vehicle 200 in FIG. 2) in operation S710. The wireless session may correspond to a feedback link.

The RSU 100 may receive state information (e.g., initial state information), which includes the position and relative velocity (e.g., an initial position and initial relative velocity) of the target vehicle 200, from the target vehicle 200 in operation S720. The state information may be received through the feedback link. The state information may correspond to an initial state vector of the target vehicle 200.

The RSU 100 may estimate a first state vector and a first covariance matrix, based on the initial state vector, in operation S730. For example, the control circuit 340 may estimate the first state vector and the first covariance matrix by using the initial state vector, based on the Kalman filter circuit 130. The Kalman filter circuit 130 may estimate the first state vector and the first covariance matrix, based on Equation 13. At this time, the first state vector and the first covariance matrix may respectively correspond to a state vector and a covariance matrix at an ( [symbol] −1)-th discrete time.

The RSU 100 may calculate a Kalman gain matrix in operation S740. In detail, the Kalman filter circuit 130 may calculate a Jacobian matrix according to Equation 15, based on the first state vector and the first covariance matrix, and may calculate a Kalman gain matrix according to Equation 25 based on the Jacobian matrix and the first covariance matrix.

The RSU 100 may calculate a correction factor based on a statistical characteristic in operation S750. The correction factor may include a state correction factor and a covariance correction factor. For example, the discretization error correction circuit 120 of the RSU 100 may obtain the state correction factor according to Equation 38. The discretization error correction circuit 120 of the RSU 100 may obtain the covariance correction factor according to Equation 39.

The RSU 100 may update the first state vector and the first covariance matrix to a second state vector and a second covariance matrix, based on the correction factor, in operation S760. For example, the discretization error correction circuit 120 may update the state vector according to Equation 36, based on the state correction factor obtained in operation S750. The discretization error correction circuit 120 may update the covariance matrix according to Equation 37, based on the covariance correction factor obtained in operation S750. The updated state vector and covariance matrix are estimated based on a value obtained by transposing a discretization error to reflect the statistical characteristic, and thus, the effect of the discretization error may be reduced. According to embodiments, the RSU 100 may track the target vehicle 200 according to the second state vector and the second covariance matrix. For example, the RSU 100 may determine and/or monitor a position and/or velocity of the target vehicle 200 based on the second state vector and the second covariance matrix. According to embodiments, the RSU 100 may generate and transmit a communication signal based on the determined and/or monitored position and/or velocity of the target vehicle 200. For example, the communication signal may include an indication of the position and/or velocity of the target vehicle 200, and/or may include guidance instructions based on the position and/or velocity of the target vehicle 200. The RSU 100 may transmit the communication signal to the target vehicle 200 (e.g., via the wireless communication circuit 310) to notify a driver of the target vehicle 200 of the position and/or velocity of the target vehicle 200, or to cause (e.g., control) the target vehicle (directly or indirectly) to change a position and/or a velocity of the target vehicle 200 in response to the communication signal. The RSU 100 may transmit the communication signal to control center (e.g., a server, etc.) corresponding to, for example, a governmental authority, a property owner, insurance provider, or another entity.

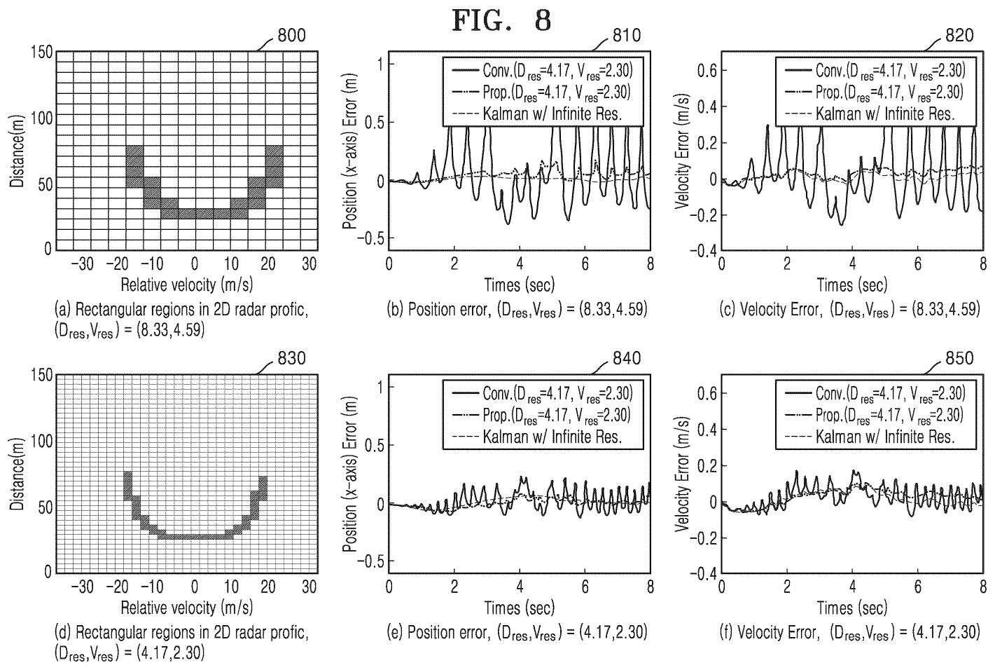

FIG. 8 shows examples of graphs showing improvement in tracking performance, according to embodiments.

Referring to FIG. 8, it is assumed that an OFDM system has a central frequency f_{c}=3.5 GHZ, a subcarrier interval Δf=30 kHz, a bandwidth of {20, 40, 80, 100} MHz, a subcarrier index N={600, 1200, 2400, 3000}, and a symbol index M={140, 280, 560, 1120}.

In this case, distance resolution may be Dᵣₑₛ={8.33, 4.17, 2.08, 1.04} m and relative velocity resolution may be Vᵣₑₛ={9.18, 4.59, 2.30, 1.15} m/s. It is also assumed that only 90% of the total system bandwidth may be used, considering a guard band.

The RSU 100 is at a position (0, 0) and has a height of 7.5 m (e.g., relative to a height of the target vehicle 200). An initial state vector of the target vehicle 200 is set to [−80 m, 75 km/h]^{T} and the distance between the target vehicle 200 and the RSU 100 on the y-axis is 30 m. In a discrete-time linear state-space model, a sampling interval is set to Tₛ=MT_{sym}, the variance of an error parameter is set to σ_{ω}=10^{-0.5}, and the error variance of distance and relative velocity is set to σ_{D}=σ_{V}=10⁻¹. For a simulation, a reflection coefficient is set as α=1.

Graphs 810 and 840 show position errors on the x-axis when an EKF-based tracking algorithm according to the related art is used. In other words, according to the graphs 810 and 840, a center value of a rectangular region (e.g., the rectangular region 400 in FIG. 4), which is generated by discrete observation according to the EKF-based tracking algorithm according to the related art, is used as is to update a state vector and a covariance matrix. Because the state vector and the covariance matrix are updated using an error involved in a discretization operator as it is, it may be seen that the range of the position error is wide from about 0.5 m to about −0.4 m. Even in the case of the EKF-based tracking algorithm according to the related art, there may be a plurality of points where the position error is 0. The positions where the position error is 0 may correspond to time points when a continuous observation vector is close to the center point of a rectangular region generated by discrete observation. According to the same principle (or a similar principle), points having a large position error in the EKF-based tracking algorithm according to the related art may correspond to time points when a continuous observation vector moves away from the center point of a rectangular region generated by discrete observation.

Graphs 820 and 850 show relative velocity errors when an EKF-based tracking algorithm according to the related art is used. In other words, according to the graphs 812 and 850, a center value of a rectangular region (e.g., the rectangular region 400 in FIG. 4), which is generated by discrete observation according to the EKF-based tracking algorithm according to the related art, is used as is to update a state vector and a covariance matrix. Because the state vector and the covariance matrix are updated using an error involved in a discretization operator as it is, it may be seen that the range of the relative velocity error is wide from about 0.4 m/s to about −0.2 m/s. Even in the case of the EKF-based tracking algorithm according to the related art, there may be a plurality of points where the relative velocity error is 0. The positions where the relative velocity error is 0 may correspond to time points when a continuous observation vector is close to the center point of a rectangular region generated by discrete observation. According to the same principle (or a similar principle), points having a large relative velocity error in the EKF-based tracking algorithm according to the related art may correspond to time points when a continuous observation vector moves away from the center point of a rectangular region generated by discrete observation. However, when the state vector and the covariance matrix are updated based on a correction factor reflecting a statistical characteristic rather than using the discretization error as it is, according to embodiments of the inventive concepts, it may be seen that the ranges of a position error and a relative velocity error are significantly reduced.

When graphs 800 and 830 are compared with each other, the size of distance resolution and relative velocity resolution corresponding to the graph 800 is (8.33, 4.59) and the size of distance resolution and relative velocity resolution corresponding to the graph 830 is (4.17, 2.30). In other words, when the resolution of the graph 830 is higher, the resolution of the graph 800 is lower. Referring to the graphs 840 and 850 respectively showing a position error and a relative velocity error when the resolution is higher, it may be seen that similar performance to an estimation algorithm based on an ideal Kalman filter is achieved.

Referring to the graphs 800 and 830, it may be seen that the size of a rectangular region generated by discrete observation when the resolution is higher is less than the size of a rectangular region generated by discrete observation when the resolution is lower. In other words, because the size of a rectangular region formed by discrete observation is large when the resolution is low in the graph 800, the difference between a continuous observation vector and the center point of the rectangular region may be larger. Accordingly, it may be seen that the error range of each of the graphs 810 and 820, which respectively show a position error and a relative velocity error when the resolution is lower, is in proportion to the size of the rectangular region formed by discrete observation.

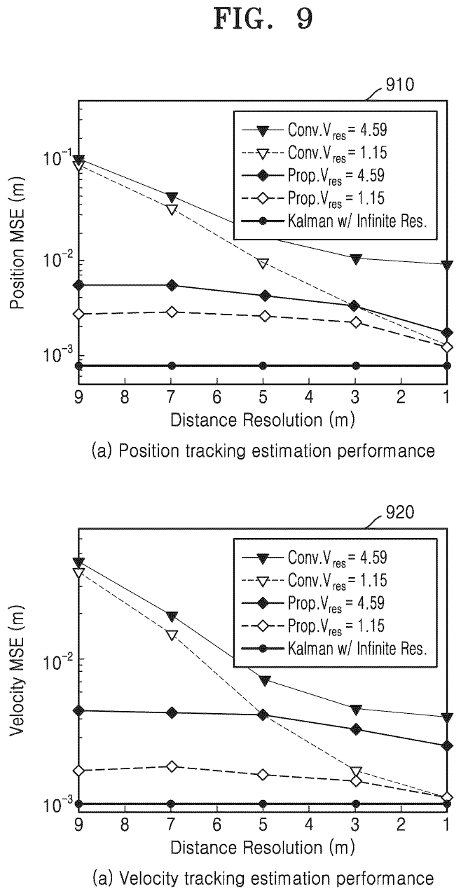

FIG. 9 shows examples of graphs showing improvement in tracking performance, according to embodiments.

Referring to FIG. 9, a graph 910 shows a position mean square error (MSE) with respect to distance resolution and a graph 920 shows a relative velocity MSE with respect to the distance resolution.

Referring to the graphs 910 and 920, it may be seen that the position MSE of a vehicle tracking algorithm according to embodiments is always (or often) lower than the position MSE of a vehicle tracking algorithm according to the related art with respect to the same relative velocity resolution (e.g., Vᵣₑₛ=1.15) (or similar relative velocity resolutions). This is because a Kalman filter uses a discrete observation vector, which has been corrected based on the statistical characteristic of a rectangular region according to discrete observation, rather than directly using a discrete observation vector including a discretization error.

Referring to the graph 910 of the position MSE and the graph 920 of the relative velocity MSE, it may be seen that in the case of higher resolution (e.g., a distance resolution of 1), the MSE is at a similar level to a vehicle tracking algorithm based on an ideal Kalman filter.

It may also be seen that the MSE slope of a proposed algorithm increases more gently than the MSE slope of a conventional algorithm. This is because the vehicle tracking algorithm of the inventive concepts gives a lower reliability to a discrete observation vector observed by a lower-resolution system. In other words, in the case of lower resolution, the size of a rectangular region according to discrete observation is larger, and accordingly, the difference between a continuous observation vector and a discrete observation vector corrected by reflecting the statistical characteristic is likely to be less than a discretization error corresponding to the difference between the continuous observation vector and the center point of the rectangular region, e.g., a discrete observation vector according to the related art.

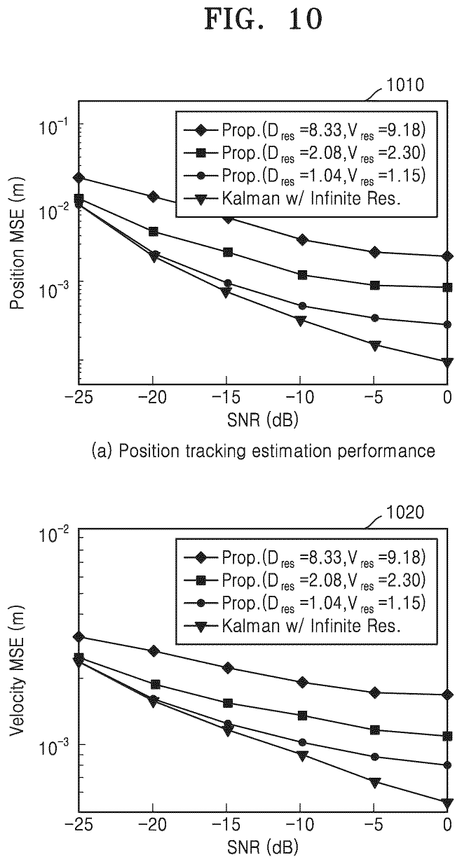

FIG. 10 shows examples of graphs showing improvement in tracking performance, according to embodiments.

Referring to FIG. 10, a graph 1010 shows a position MSE with respect to a signal-to-noise ratio (SNR) and a graph 1020 shows a relative velocity MSE with respect to an SNR.

Referring to the graphs 1010 and 1020, it may be seen that the position MSE and the relative velocity MSE decrease as the SNR increases. It may also be seen that estimation performance increases as distance resolution and relative velocity resolution increase. When the SNR is lower, there is no difference (or less difference) in performance between a vehicle tracking algorithm based on an ideal Kalman filter and a vehicle tracking algorithm according to the inventive concepts. This is because the effect of noise is so large that a discretization error involved in discrete observation is negligible.

Conventional devices and methods for OFDM-based radar detection of a vehicle experience discretization error in observed values (e.g., observed values of the vehicle's position and/or velocity). As a result of this discretization error, the OFDM-based radar detection of the conventional devices and methods is insufficiently accurate for, e.g., use in vehicle tracking applications.

However, according to embodiments, improved devices and methods are provided for OFDM-based radar detection of a vehicle. The improved devices and methods may calculate a correction factor, and use the correction factor to remove and/or reduce a discretization error in observed values (e.g., observed values of the vehicle's position and/or velocity). For example, the correction factor may be used to update a state vector and/or covariance matrix of the vehicle to remove and/or reduce a discretization error in observed values (e.g., observed values of the vehicle's position and/or velocity). Accordingly, the improved devices and methods may overcome the deficiencies of the conventional devices and methods to at least improve the accuracy of OFDM-based radar detection.

According to embodiments, operations described herein as being performed by the vehicle tracking system 10, the RSU 100, the target vehicle 200, the discretization error correction circuit 120, the Kalman filter circuit 130, the wireless communication circuit 310, the backhaul communication circuit 320 and/or the control circuit 340 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 330). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

Although terms of “first” or “second” may be used to explain various components, the components are not limited to the terms. These terms should be used only to distinguish onc component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

While the inventive concepts have been particularly shown and described with reference to embodiments thereof, it will be understood that various changes in form and details may be made therein without departing from the spirit and scope of the following claims.

What is claimed is:

1. An electronic device comprising:
an antenna configured to receive an orthogonal frequency division multiplex (OFDM) signal reflected from a target vehicle; and
processing circuitry configured to
estimate a first state vector and a first covariance matrix based on initial state information, the initial state information being received from a target vehicle via a wireless connection,
calculate a Kalman gain matrix based on the first state vector and the first covariance matrix,
calculate a correction factor based on a statistical characteristic of a discrete observation vector, and
update the first state vector and the first covariance matrix based on the correction factor to obtain a second state vector and a second covariance matrix.

2. The electronic device of claim 1, wherein
the correction factor includes a state correction factor and a covariance correction factor; and
the processing circuitry is configured to:
update the first state vector based on the state correction factor to obtain the second state vector, and
update the first covariance matrix based on the covariance correction factor to obtain the second covariance matrix.

3. The electronic device of claim 2, wherein the processing circuitry is configured to calculate the correction factor including:
transforming a conditional posterior probability density function into a normal distribution at a first discrete time; and
determining the state correction factor and the covariance correction factor based on
a mean vector of the normal distribution, and
a covariance of the normal distribution.

4. The electronic device of claim 1, wherein the processing circuitry is configured to calculate the Kalman gain matrix based on the first covariance matrix and a Jacobian matrix, the Jacobian matrix being a matrix of partial derivatives of a non-linear transformation of a first state vector.

5. The electronic device of claim 1, wherein
the electronic device corresponds to a road side unit (RSU), and
the wireless connection corresponds to a feedback link.

6. The electronic device of claim 1, wherein the antenna is configured to broadcast an OFDM-based radar signal to the target vehicle, the OFDM signal being based on the OFDM-based radar signal.

7. The electronic device of claim 1, wherein the initial state information includes a position of the target vehicle and a relative velocity of the target vehicle.

8. An operating method of an electronic device, the operating method comprising:
estimating a first state vector and a first covariance matrix based on initial state information, the initial state information being received from a target vehicle via a wireless connection;
calculating a Kalman gain matrix based on the first state vector and the first covariance matrix;
calculating a correction factor based on a statistical characteristic of a discrete observation vector; and
updating the first state vector and the first covariance based on the correction factor to obtain a second state vector and a second covariance matrix.

9. The operating method of claim 8, wherein
the correction factor includes a state correction factor and a covariance correction factor; and
the updating comprises:
updating the first state vector based on the state correction factor to obtain the second state vector, and
updating the first covariance matrix based on the covariance correction factor to obtain the second covariance matrix.

10. The operating method of claim 9, wherein the calculating the correction factor includes:
transforming a conditional posterior probability density function into a normal distribution at a first discrete time; and
determining the state correction factor and the covariance correction factor based on
a mean vector of the normal distribution, and
a covariance of the normal distribution.

11. The operating method of claim 8, wherein the calculating the Kalman gain matrix comprises calculating the Kalman gain matrix based on the first covariance matrix and a Jacobian matrix, the Jacobian matrix being a matrix of partial derivatives of a non-linear transformation of a first state vector.

12. The operating method of claim 8, wherein
the electronic device corresponds to a road side unit (RSU), and
the wireless connection corresponds to a feedback link.

13. The operating method of claim 8, further comprising:
broadcasting an OFDM-based radar signal to the target vehicle; and
receiving a reflected OFDM signal, the reflected OFDM signal corresponding to the OFDM-based radar signal reflected from the target vehicle.

14. The operating method of claim 8, wherein the initial state information includes a position of the target vehicle and a relative velocity of the target vehicle.

15. A non-transitory computer-readable medium storing instructions that, when executed by at least one processor, cause the at least one processor to perform an operating method, the operating method comprising:
estimating a first state vector and a first covariance matrix based on initial state information, the initial state information being received from a target vehicle via a wireless connection;
calculating a Kalman gain matrix based on the first state vector and the first covariance matrix;
calculating a correction factor based on a statistical characteristic of a discrete observation vector; and
updating the first state vector and the first covariance based on the correction factor to obtain a second state vector and a second covariance matrix.

16. The non-transitory computer-readable medium of claim 15, wherein
the correction factor includes a state correction factor and a covariance correction factor; and
the updating comprises:
updating the first state vector based on the state correction factor to obtain the second state vector, and
updating the first covariance matrix based on the covariance correction factor to obtain the second covariance matrix.

17. The non-transitory computer-readable medium of claim 16, wherein the calculating the correction factor includes:
transforming a conditional posterior probability density function into a normal distribution at a first discrete time; and
determining the state correction factor and the covariance correction factor based on
a mean vector of the normal distribution, and
a covariance of the normal distribution.

18. The non-transitory computer-readable medium of claim 15, wherein the calculating the Kalman gain matrix comprises calculating the Kalman gain matrix based on the first covariance matrix and a Jacobian matrix, the Jacobian matrix being a matrix of partial derivatives of a non-linear transformation of a first state vector.

19. The non-transitory computer-readable medium of claim 15, wherein
the at least one processor is included in a road side unit (RSU), and
the wireless connection corresponds to a feedback link.

20. The non-transitory computer-readable medium of claim 15, wherein the operating method further comprises:
broadcasting an OFDM-based radar signal to the target vehicle; and
receiving a reflected OFDM signal, the reflected OFDM signal corresponding to the OFDM-based radar signal reflected from the target vehicle.
